(19) United States
(12) Patent Application Publication
(10) Pub. No.: US 2010/0110551 A1
(43) Pub. Date: May 6, 2010

(54) LIGHT EXTRACTION FILM WITH HIGH INDEX BACKFILL LAYER AND PASSIVATION LAYER

(75) Inventors: Sergey A. Lamansky, Apple Valley, MN (US); Encai Hao, Woodbury, MN (US); Ha T. Le, Saint Paul, MN (US); David B. Stegall, Austin, TX (US); Ding Wang, Austin, TX (US); Yi Lu, Austin, TX (US); Terry L. Smith, Roseville, MN (US); Jun-Ying Zhang, Woodbury, MN (US); Jung-Sheng Wu, Woodbury, MN (US); James E. Thorson, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/262,393

(22) Filed: Oct. 31, 2008

(51) Int. Cl. G02B 5/02; B05D 5/06; G02B 27/56

(52) U.S. Cl. 359/599; 427/162

(57) ABSTRACT

A multifunctional optical film for enhancing light extraction includes a flexible substrate, a structured layer, a high index backfill layer, and an optional passivation layer. The structured layer effectively uses microreplicated diffractive or scattering nanostructures located near enough to the light generation region to enable extraction of an evanescent wave from an organic light emitting diode (OLED) device. The backfill layer has a material having an index of refraction different from the index of refraction of the structured layer. The backfill layer also provides a planarizing layer over the structured layer in order to conform the light extraction film to a layer of an OLED display device. The film may have additional layers added to or incorporated within it to an emissive surface in order to effect additional functionalities beyond improvement of light extraction efficiency.

### BACKGROUND

Organic Light Emitting Diodes (OLEDS) are the basis for a new display and lighting technology, providing a good match for high resolution or high pixel count high definition display applications, and for efficient, broad area, flexible lighting applications. OLED devices include a thin film of electroluminescent organic material sandwiched between a cathode and an anode, with one or both of these electrodes being a transparent conductor. When a voltage is applied across the device, electrons and holes are injected from their respective electrodes and recombine in the electroluminescent organic material through the intermediate formation of emissive excitons.

In OLED devices, over 70% of the generated light is typically lost due to processes within the device structure. The trapping of light at the interfaces between the higher index organic and Indium Tin Oxide (ITO) layers and the lower index substrate layers is the major cause of this poor extraction efficiency. Only a relatively small amount of the emitted light emerges through the transparent electrode as “useful” light. The majority of the light undergoes internal reflections, which result in its being emitted from the edge of the device or trapped within the device and eventually being lost to absorption within the device after making repeated passes.

Efforts have been made to improve the internal quantum efficiency (number of photons generated per electron injected) of OLEDs by means such as modifying the charge injection or transport layers, using fluorescent dyes or phosphorescent materials, or by using multilayer structures (see, for example, K. Meerholz, Adv. Funct. Materials v. 11, no. 4, p 251 (2001)). Light extraction efficiency (number of photons emerging from the structure vs. the number generated internally) can be influenced by factors external to the emission layers themselves.

A bottom emitting OLED may be thought of as consisting of a core containing high index of refraction layers (organic layers for light generation, carrier transport, injection or blocking, and, typically, a transparent conductive oxide layer) and a low index of refraction substrate material (typically glass, but could be a polymer film). Therefore light that is generated within the core may encounter two high index to low-index interfaces where it might undergo internal reflection. Light unable to escape the core as a result of encounter at the first interface is confined to a waveguide mode, while light passing through that interface but unable to escape from the substrate as a result of reflection at the substrate-to-air interface is confined to a substrate mode. Similar optical losses occur due to interfaces in top emitting OLEDs.

Various solutions have been proposed to affect light reaching the substrate-to-air interface by disturbing that interface (e.g., microlenses or roughened surfaces). Others have introduced scattering elements into the substrate or into an adhesive (see Published PCT Application No. WO2002037580A1 (Chou)), thereby interrupting the substrate modes to redirect that light out of the device. There have even been some preliminary attempts to disturb the core-to-substrate interface by introducing scattering or diffractive elements at this interface. Detailed analysis has shown that scattering or diffracting structures will be most effective in extraction light when located at this interface (M. Fujita, et al.; Jpn. J. Appl. Phys. 44 (6A), pp. 3669-77 (2005)). Scattering efficiency is maximized when the index contrast between the scattering or diffractive elements and the backfill material is large and when the length scale of the index contrast variations is comparable to the wavelength of the light (see, for example, F. J. P. Schuurmans, et al.; Science 284 (5411), pp. 141-143 (1999)).

Fabrication of defect-free OLED devices in contact with this light extracting layer will require a smooth planar surface, so planarity of the top surface of a light extraction film is important. There has been, however, some work on corrugating the electrode structure in order to couple light out of the OLED (M. Fujita, et al.; Jpn. J. Appl. Phys. 44 (6A), pp. 3669-77 (2005)); the resultant effects on the electric fields in the device are expected to have deleterious effects. So great care must be taken to not adversely affect the electrical operation of the device while disturbing this interface. Practical solutions to balancing these conflicting issues have not yet been proposed.

Similar problems in external efficiency exist with inorganic light-emitting diodes (LEDs), where the very high refractive indices of the active materials can severely limit the extraction of internally generated light. In these cases, there have been some attempts to utilize photonic crystal (PC) materials to improve the extraction efficiency (S. Fan, Phys. Rev. Letters v. 78, no. 17, p. 3294 (1997); H. Ichikawa, Appl. Phys. Letters V. 84, p. 457 (2004)). Similar reports on the use of PCs in connection with OLED efficiency improvement have begun to appear (M. Fujita, Appl. Phys. Letters v. 85, p. 5769 (2004); Y. Lee, Appl. Phys. Letters v. 82, p. 3779 (2003)), but previously reported results have involved time-consuming and costly procedures which do not lend themselves incorporation into existing OLED fabrication processes.

Accordingly, a need exists for a product which can enhance light extraction from OLED devices in a form which is compatible with fabrication processes for these devices.

### SUMMARY

A multifunctional optical film for enhancing light extraction, consistent with the present invention, includes a flexible substrate, a structured layer, and a backfill layer. The structured layer of extraction elements has a first index of refraction, and a substantial portion of the extraction elements are in optical communication with a light emitting region of a self-emissive light source when the optical film is located against the self-emissive light source. The backfill layer has a material having a second index of refraction different from the first index of refraction, and a difference between the indices of refraction of the structured layer and the backfill layer is greater than or equal to 0.3. The backfill layer also forms a planarizing layer over the extraction elements. The film may optionally have a passivation layer located adjacent the backfill layer on a side opposite the structured layer.

A method of making a multifunctional optical film for enhancing light extraction, consistent with the present invention, includes coating a layer of a material having a first index of refraction onto a flexible substrate. Nanostructured features are imparted into the organic material to create a nanostructured surface. The organic material having the nanostructured features is cured. A backfill layer is then applied to the nanostructured surface to form a planarizing layer on the nanostructured surface. The backfill layer comprises a material having a second index of refraction different from the first index of refraction, and a difference between the indices of refraction of the nanostructured features and the backfill layer is greater than or equal to 0.3. The method can optionally include applying a passivation layer over the backfill layer after it is applied over the nanostructured surface.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a bottom emitting OLED display device with a light extraction film;

FIG. 2 is a diagram of a top emitting OLED display device with a light extraction film;

FIG. 3 is a diagram illustrating spatially modulated OLEDs for a solid state lighting element;

FIG. 4 is a diagram of an OLED backlight unit with a light extraction film;

FIG. 5 is a diagram illustrating OLEDs used as an LCD backlight unit;

FIGS. 6-8 are diagrams depicting possible spatial configurations of extraction elements; and

FIGS. 9-13 are diagrams depicting possible surface configurations of extraction elements.

### DETAILED DESCRIPTION

Embodiments include methods to form light-extracting nanostructures, or other nanostructures, in a polymer replication process, a direct deposition of nanoparticles, or other processes to make a light extraction film for OLED devices. The multifunctional film product can, in addition to enhancing light extraction, serve additional functions such as a substrate, encapsulant, barrier layer, filter, polarizer, or color converter and may be employed either during or after manufacture of an OLED device. The film construction is based upon photonic crystal structures, or other nanostructures, for improved efficiency of light extraction from the devices by modifying the interface between high and low index layers within the device.

Elements of the invention include the provision of structures of dimensions comparable to or less than the wavelength of the light to be controlled, the provision of a material with contrasting index of refraction to fill in the areas surrounding the structures and also to planarize the structure in order to present an essentially smooth surface to come in contact with the OLED structure, and the location of this index-contrasting nanostructured layer within a small enough distance from the light-emitting region to be effective in extracting the light that would otherwise be trapped in that region. The planarization obtained with the high index material should be sufficient to ensure similar current-voltage behavior of the OLED devices fabricated with and without the light extraction film.

Light incident from a high index material onto an interface with a lower index medium will undergo total internal reflection (TIR) for all incidence angles greater than the critical angle θ_{C}, defined by θ_{C}=sin⁻¹ (n₂/n₁), where n₁ and n₂ are the refractive indices of the high- and low-index regions, respectively. The electromagnetic field associated with this light reflected by TIR extends into the lower-index region in an evanescent standing wave, but the strength of this field diminishes exponentially with distance from the interface. Absorbing or scattering entities located within this evanescent zone, typically about one wavelength thick, can disrupt the TIR and cause the light to pass through the interface. Therefore, it is preferable that the nanostructured index contrast layer be located within the evanescent zone if it is to be most effective in causing extraction of the light from the emission region by scattering or diffraction. Alternative, the nanostructured index contrast layer need only be in optical communication with a light emitting region of the self-emissive light source when the optical film is located against the self-emissive light source. The term “optical communication” means that a significant or substantial portion of the generated optical field from the light source is capable to reach the scattering particles or nanostructure.

Replication master tools can be fabricated with regular or random structures of the required average periodicity for light extraction, 200 nanometers (nm)-2000 nm, over increasingly larger areas. Combining this tooling capability with microreplication processes such as continuous cast and cure (3C) enable the formation of the photonic crystal structures, or other nanostructures, on the surface of a film substrate. Examples of a 3C process are described in the following patents, all of which are incorporated herein by reference: U.S. Pat. Nos. 4,374,077; 4,576,850; 5,175,030; 5,271,968; 5,558,740; and 5,995,690.

The terms “nanostructure” or “nanostructures” refers to structures having at least one dimension (e.g., height, length, width, or diameter) of less than 2 microns and more preferably less than one micron. Nanostructure includes, but is not necessarily limited to, particles and engineered features. The particles and engineered features can have, for example, a regular or irregular shape. Such particles are also referred to as nanoparticles.

The term “nanostructured” refers to a material or layer having nanostructures.

The term “photonic crystal structures” refers to periodic or quasi-periodic optical nanostructures interspersed with a material of sufficiently different index of refraction that will enable the structure to produce gaps in the spectrum of allowed electromagnetic modes in the material.

The term “index” refers index of refraction.

The term “backfill” refers to the material incorporated into a structure, and of a different index from the structure, to fill in voids in the structure and planarize the structure.

The term “extraction elements” refers to any type and arrangement of nanostructures enhancing light extraction from self-emissive light sources. The extraction elements are preferably not contained within a volume distribution.

### Bottom Emitting OLED Display Device

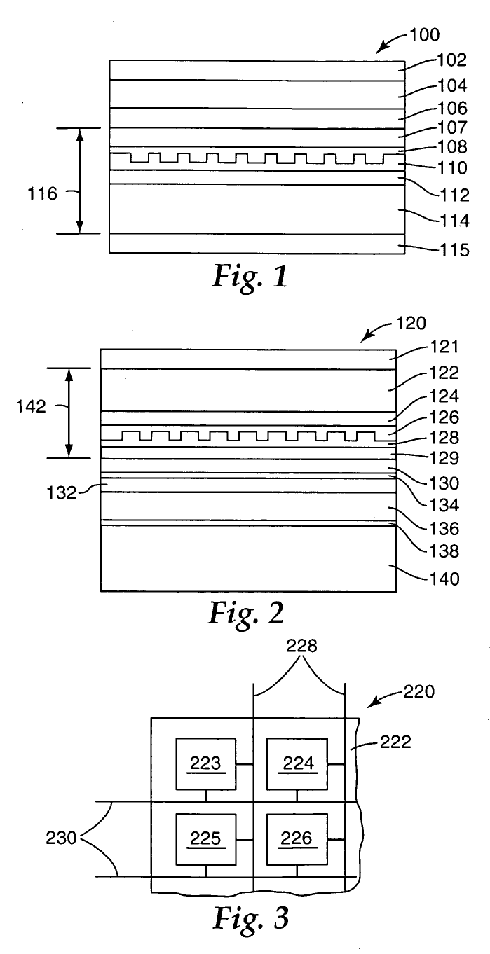

FIG. 1 illustrates a structure of bottom emitting OLED device 100 with a film substrate having a light extraction film. A bottom emitting OLED device is defined as an OLED device emitting light through the substrate. Table 1 describes the exemplary elements of device 100 and the arrangement of those elements, as identified by the reference numbers provided in FIG. 1. Each layer of device 100 can be coated on or otherwise applied to the underlying layer.

TABLE 1
Bottom Emitting OLED Device with Light Extraction Film

| Ref. No. | Type of Element |
|---|---|
| 102 | electrode 1 |
| 104 | organic layers |
| 106 | electrode 2 |
| 107 | passivation layer |
| 108 | high index structure |
| 110 | low index structure |
| 112 | optional barrier layer |
| 114 | substrate |
| 115 | optional functional layers |
| 116 | light extraction film |

The substrate 114 is composed of a material, substantially transparent (transmissive) to the desired emitted wavelengths, that provides sufficient mechanical support and thermal stability for the device. Substrate 114 preferably comprises a flexible material. Examples of substrate materials include the following: glass; flexible glass; polyethylene terephthalate (“PET”); polyethylene naphthalate (“PEN”); or other translucent or transparent materials. Substrate 114 can optionally also function as a barrier layer. Also, substrate 114 can optionally contain dyes or particles, and it can be tentered or include prismatic structures.

The optional barrier layer 112 effectively blocks or helps prevent permeation of oxygen and water to the layers of the device, particularly the organic layers. Examples of barrier layers are described in U.S. Patent Application Publication Nos. 2006/0063015 (describing boron oxide layers with inorganic barrier layers) and 2007/0020451 (describing diamond-like glass (DLG) and diamond-like carbon (DLC)), both of which are incorporated herein by reference.

The electrodes 102 and 106 can be implemented with, for example, transparent conductive oxide (TCO) such as indium tin oxide (ITO) or metals with the appropriate work function to make injection of charge carriers such as calcium, aluminum, gold, or silver.

The organic layers 104 can be implemented with any organic electroluminescent material such as a light-emitting polymer, an example of which is described in U.S. Patent No. 6,605,483, which is incorporated herein by reference. Other examples of suitable light emitting materials include evaporated small molecule materials, light-emitting dendrimers, molecularly doped polymers, and light-emitting electrochemical cells.

The light extraction film 116 in this embodiment is composed of substrate 114, optional barrier layer 112, low index structure 110, and high index structure 108. The high index structure uses a backfill medium to effectively provide a planarizing layer over the low index structure in order to make the light extraction film sufficiently planar to allow OLED fabrication. The backfill layer can alternatively have other optical properties. Also, the backfill layer material can function as a barrier to moisture and oxygen or provide electrical conduction, possibly in addition to having barrier properties, depending upon the type of material used. The backfill layer can alternatively be implemented with an optically clear adhesive, in which case the extraction film can be applied to top emitting OLED device, for example.

In some embodiments, the backfill layer can be implemented with compositions of extremely high refractive index (RI) coating (RI>1.8) and their applications as planarizing backfill materials for index-contrast-based OLED light extraction nanostructured films. With the high index backfill layer, the difference between an index of refraction of the structured layer (or nanoparticles) and an index of refraction of the backfill layer is preferably greater than or equal to 0.3. With such a difference in indices of refraction, the structured layer (or nanoparticles) preferably has an index of refraction less than or equal to 1.5.

These high index backfill compositions described in the present specification have been demonstrated to double light output of OLED devices. These embodiments can provide for the following features, for example: efficient internal nanostructure-based light extraction film for high-resolution OLED displays; efficient internal nanostructure-based light extraction film for OLED lighting devices; and low-cost roll-to-roll fabrication of the nanostructure based light extraction film for OLED displays and lighting.

The low index structure 110 has a material with an index substantially matched to the underlying layer, typically the substrate. The low index structure 110 is composed of a nanostructured layer, which can have a periodic, quasi-periodic, or random distribution or pattern of optical nanostructures, including photonic crystal structures. It can include discrete nanoparticles. The nanoparticles can be composed of organic materials or other materials, and they can have any particle shape. The nanoparticles can alternatively be implemented with porous particles. The distribution of nanostructures can also have varying pitches and feature size. At least a portion of the extraction elements or nanostructures are preferably in contact with the flexible substrate, and the extraction elements may have voids beneath them. The layer of nanoparticles can be implemented with nanoparticles in a monolayer or with a layer having agglomerations of nanoparticles.

Using a thickness of the nanostructures on the order of the evanescent wave from the organic layers can result in coupling of the evanescent wave to the nanostructures for extraction of additional light from the device. This coupling preferably occurs when the light extraction film is adjacent to the light emitting region of the self-emissive light source. When the backfill layer has a lower index than the structured layer, then the backfill layer preferably has a thickness substantially equal to the extraction elements. When the backfill layer has a higher index than the structured layer, then the backfill layer can be thicker than the extraction elements provided it can still interact with the evanescent wave. In either case, the structured layer and backfill layer are preferably in sufficient proximity to the light output surface in order to at least partially effect the extraction of light from that surface.

The nanostructured features in layer 110 can be fabricated using any printing techniques for replication of submicron features such as the following: imprinting; embossing; nanoimprinting; thermal- or photo-nanoimprint lithography; injection molding; or nanotransfer printing. Another technique for fabricating the extraction elements is described in Example 18 in U.S. Pat. No. 6,217,984, which is incorporated herein by reference.

The high index structure 108 is a high index material providing index contrast to the adjacent low index nanostructured layer and provides an effective planarization layer to it. The index of refraction mismatch between nanostructured layer 110 and backfill medium 108 at the emission wavelength(s) is referred to as Δn, and a greater value of Δn generally provides better light extraction. The value of Δn is preferably greater than or equal to 0.3, 0.4, 0.5, or 1.0. Any index mismatch between the extraction elements and backfill medium will provide for light extraction; however, a greater mismatch tends to provide greater light extraction and is thus preferred. Examples of suitable materials for backfill medium 108 include the following: high index inorganic materials; high index organic materials; a nanoparticle filled polymer material; silicon nitride; polymers filled with high index inorganic materials; and high index conjugated polymers. Examples of high index polymers and monomers are described in C. Yang, et al., Chem. Mater. 7, 1276 (1995), and R. Burzynski, et al., Polymer 31, 627 (1990) and U.S. Pat. No. 6,005,137, all of which are incorporated herein by reference. Examples of polymers filled with high index inorganic materials are described in U.S. Pat. No. 6,329,058, which is incorporated herein by reference. Examples of nanoparticles for the nanoparticle filled polymer material include the following high index materials: TiO₂, ZrO₂, HfO₂, or other inorganic materials. The backfill layer can be applied to form the planarizing layer using, for example, one of the following methods: liquid coating; vapor coating; powder coating; lamination; dip-coating; or roll-to-roll coating.

Passivation layer 107 can provide for aging stability of an OLED incorporating the light extraction film. Passivation layer 107 can be implemented with a thin layer, for example a 60 nm-thick layer, of silicon nitride on top of the high index polymer backfill layer as shown in FIG. 1. The passivation layer overcomes degradation processes observed when the OLED emitting layers are in direct contact with nanoparticle-based high index backfills. The passivation layer is incorporated at the interface between the high index backfill layers in the nanostructured light extraction film and the OLED electrode materials such as indium-tin-oxide (ITO). It is believed that the passivation layer significantly reduces decay processes occurring at the backfill/ITO interface thereby improving overall OLED device stability. Passivation layer 107 can be implemented with, for example, an optically transparent high index material with low permeability, such as the following: Si₃N₄, ZrO₂, TiO₂, HfO₂, Ta₂O₅, Al₂O₃, as well as their silicates, and the like.

Functionality can be added to the construction by depositing on it a transparent conductor such as ITO (n≈1.9-2.1) with high index, high transparency and low sheet resistivity, to serve as the anode for the OLED device. The ITO can even be used as the backfill for the structure, if the layer can fill the structures and form into a smooth layer without adverse effects on the optical or electrical properties. Alternatively, after backfilling and smoothing, alternating metallic and organic layers may be deposited to form a transparent conductive overlayer in the manner as described in U.S. Patent Application Publication No. 2004/0033369, which is incorporated herein by reference.

Additional flexibility in the functionality of the extractor pattern of the photonic crystal structures or nanostructures can be obtained through the use of photonic quasicrystal structures. These quasicrystal structures are designed using tiling rules; they have neither true periodicity nor translation symmetry but have a quasi-periodicity with long-range order and orientation symmetry, examples of which are described in the following reference, which is incorporated herein by reference: B. Zhang et al., “Effects of the Artificial Ga-Nitride/Air Periodic Nanostructures on Current Injected GaN-Based Light Emitters,” Phys. Stat. Sol. (c) 2(7), 2858-61 (2005). The photonic quasicrystal structures offer the possibility of a pseudogap for all propagation directions, and they exhibit unique light scattering behaviors. In particular, these patterns of quasiphotonic crystal structures can eliminate artifacts resulting from the regularity of conventional photonic crystal structures, and they can be used to tailor unique light emission profiles and possibly can eliminate undesirable chromatic effects when working with broadband OLED emitters. Photonic crystal structures are described in the following patents, all of which are incorporated herein by reference: U.S. Pat. Nos. 6,640,034; 6,901,194; 6,778,746; 6,888,994; 6,775,448; and 6,959,127.

Embodiments can involve the incorporation of the diffractive or scattering nanostructures into a film product which could be continuously produced, for example, on a web line having a polymer film or ultrabarrier coated film substrate fed to a 3C replication process followed by deposition of a high index backfill medium. Alternate ways to incorporate the diffractive or scattering nanoparticles into the film include solution coating a dispersion of particles. This film can be designed to be used directly as the substrate on which a bottom emitting OLED is fabricated, enabling the production of a film capable of many uses in addition to enhancing light extraction.

Additional functionality could be incorporated into the light extraction film product by forming the extraction structures on an optional ultrabarrier film, which provides excellent moisture and oxygen barrier properties. Ultrabarrier films include multilayer films made, for example, by vacuum deposition of two inorganic dielectric materials sequentially in a multitude of layers on a glass or other suitable substrate, or alternating layers of inorganic materials and organic polymers, as described in U.S. Pat. Nos. 5,440,446; 5,877,895; and 6,010,751, all of which are incorporated herein by reference.

Materials may also be incorporated within the film to enhance light extraction through scattering or to filter, color shift, or polarize the light. Finally, surface coatings or structures, for example functional layers 115, can be applied to the air surface of the light extraction film in order to further increase the functionality and possibly value of a light extraction film. Such surface coatings can have, for example, optical, mechanical, chemical, or electrical functions. Examples of such coatings or structures include those having the following functions or properties: antifog; antistatic; antiglare; antireflection; antiabrasion (scratch resistance); antismudge; hydrophobic; hydrophilic; adhesion promotion; refractive elements; color filtering; ultraviolet (UV) filtering; spectral filtering; color shifting; color modification; polarization modification (linear or circular); light redirection; diffusion; or optical rotation. Other possible layers to be applied to the air surface include a barrier layer or a transparent electrically conductive material.

### Top Emitting OLED Display Device

FIG. 2 illustrates a structure of top emitting OLED device 120 with a film substrate having a light extraction film. Table 2 describes the exemplary elements of the device 120 and the arrangement of those elements, as identified by the reference numbers provided in FIG. 2. Each layer of the device can be coated on or otherwise applied to the underlying layer. The configurations shown in FIGS. 1 and 2 are provided for illustrative purposes only, and other configurations of bottom emitting and top emitting OLED display devices are possible.

TABLE 2
Top Emitting OLED Device with Light Extraction Film

| Ref. No. | Type of Element |
|---|---|
| 121 | optional functional layers |
| 122 | substrate 1 |
| 124 | optional barrier layer |
| 126 | low index structure |
| 128 | high index structure |
| 129 | passivation layer |
| 130 | optical coupling layer |
| 132 | electrode 1 |
| 134 | optional thin film encapsulant layer |
| 136 | organic layers |
| 138 | electrode 2 |
| 140 | substrate 2 |
| 142 | light extraction film |

The light extraction film 142 in this embodiment is composed of substrate 122, optional barrier layer 124, low index structure 126, and high index structure 128. Low index structure 126 and high index structure 128 can be implemented with the exemplary materials and constructions described above, and high index structure 128 is preferably a high index backfill material as described above. Layers 128 and 130 can optionally be implemented with a single layer. The substrates 122 and 140, optional barrier layer 124, electrodes 132 and 138, organic layers 136, and passivation layer 129 can be implemented with the exemplary materials identified above.

Optional thin film encapsulant 134 can be implemented with, for example, any suitable material for protecting the organic layers from moisture and oxygen. Examples of encapsulants for OLED devices are described in U.S. Pat. No. 5,952,778 and U.S. patent application Ser. No. 11/424997, filed Jun. 19, 2006, both of which are incorporated herein by reference.

OLED devices, especially top emitting OLED devices as shown in FIG. 2, are optionally completed by depositing a thin film encapsulant, typically on a semitransparent electrode. This construction of an OLED device provides an advantage; in particular it creates access to the critical high index device-air interface after the completion of device fabrication, enabling a lamination process for the application of the light extraction film. For top emitting OLED devices, embodiments include a light extraction film as described above for bottom emitting OLED devices. Alternatively, the film can be designed to be the capping layer on a top emitting OLED structure when combined with a suitable high index adhesive to serve as the optical layer 130 in order to optically couple the OLED device to the light-extracting layer. The encapsulant material may itself serve as the index contrast material which backfills the nanostructures to form the light extraction layer.

### OLED Solid State Lighting Element

Top emitting OLED device 120 or bottom emitting OLED device 100 can also be used to implement an OLED solid state lighting element. In addition to the substrates identified above, examples of substrates useful in top emitting OLED solid state lighting devices, including flexible metal foils, are described in the following papers, all of which are incorporated herein by reference: D. U. Jin et al., “5.6-inch Flexible Full Color Top Emission AMOLED Display on Stainless Steel Foil,” SID 06 DIGEST, pp. 1855-1857 (2006); and A. Chwang et al., “Full Color 100 dpi AMOLED Displays on Flexible Stainless Steel Substrates,” SID 06 DIGEST, pp. 1858-1861 (2006).

FIG. 3 is a diagram illustrating a device 220 having spatially modulated OLED devices for use in solid state lighting devices. Device 220 includes a substrate 222 supporting a plurality of OLED devices 223, 224, 225, and 226, each of which may correspond with the structures described above with respect to bottom or top emitting OLED display devices. Each of the OLED devices 223-226 can be individually controlled as represented by lines 228 and 230, which would provide electrical connections to the anodes and cathodes in devices 223-226. Device 220 can include any number of OLED devices 223-226 with electrical connections, and substrate 222 can be scaled to accommodate them. The individual control of devices 223-226, via connections 228 and 230, can provide for spatial modulation of them such that they are individually or in groups lighted in a particular sequence or pattern. Device 220 can be used in solid state light, for example, on a rigid or flexible substrate 222.

### OLED Backlight Unit

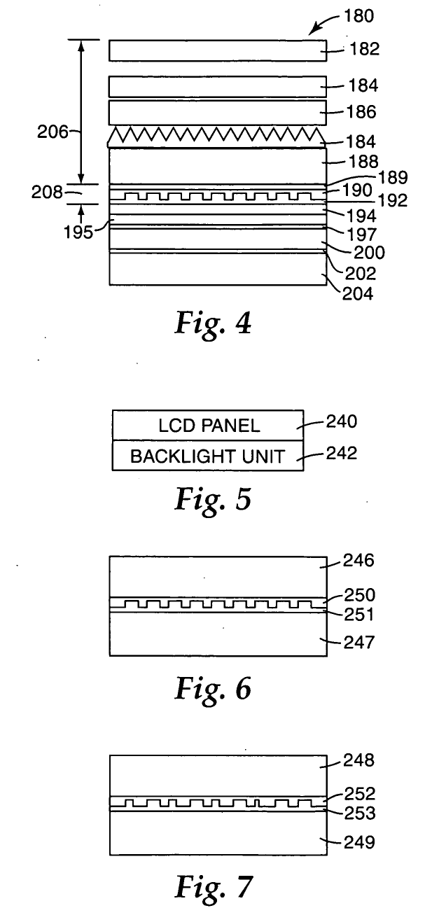

FIG. 4 is a diagram of a top emitting OLED backlight unit 180 with light extraction film. Table 3 describes the exemplary elements of the backlight unit 180 and the arrangement of those elements, as identified by the reference numbers provided in FIG. 4. Each layer of backlight unit 180 can be coated on or otherwise applied to the underlying layer. Alternatively, bottom emitting OLEDs can also be used for backlight units.

TABLE 3
OLED Backlight Unit with Light Extraction Film

| Ref. No. | Type of Element |
|---|---|
| 182 | polarizer |
| 184 | optional prism layer |
| 186 | optional asymmetric reflective film |
| 188 | optional diffuser |
| 189 | substrate 1 |
| 190 | low index structure |
| 192 | high index structure |
| 194 | optical coupling layer |
| 195 | optional thin film encapsulant layer |
| 197 | electrode 1 |
| 200 | organic layers |
| 202 | electrode 2 |
| 204 | substrate 2 |
| 206 | auxiliary optical films |
| 208 | light extraction film |

The light extraction film 208 in this embodiment is composed of optional prism layer 184, optional diffuser 188, low index structure 190, and high index structure 192. Low index structure 190 and high index structure 192 can be implemented with the exemplary materials and constructions described above. The other elements of this embodiment, as provided in Table 3, can be implemented with the exemplary materials identified above. Layers 192 and 194 can alternatively be implemented with a single layer.

FIG. 5 is a diagram illustrating OLED devices used as a liquid crystal display (LCD) backlight unit 242 for an LCD panel 240. Backlight unit 242 may correspond with the structure 180. The backlight unit 242 can alternatively be implemented with the spatially modulated light panel shown in FIG. 3. LCD panel 240 typically includes the entire LCD device except the backlight and drive electronics. For example, LCD panel 240 typically includes the backplane (subpixel electrodes), front and back plates, liquid crystal layer, color filter layer, polarizing filters, and possibly other types of films. Use of OLED devices as a backlight may provide for a thin, low power backlight for LCDs. An example of LCD panel components and a backlight unit are described in U.S. Pat. No. 6,857,759, which is incorporated herein by reference.

High index/Low Index Regions and Surface Configurations

FIGS. 6-8 are diagrams depicting the possible spatial configurations of extraction elements. FIG. 6 illustrates a low index structure 250, having a regular pattern of nanostructures, with a high index structure 251 providing a planarizing layer over the nanostructures. The structures 250 and 251 are located between a low index substrate 246 and an OLED device region 247. FIG. 7 illustrates a low index structure 252, having an irregular pattern of nanostructures, with a high index structure 253 providing a planarizing layer over the nanostructures. The structures 252 and 253 are located between a low index substrate 248 and an OLED device region 249. In FIGS. 6 and 7, the low and high index structures are located between a substrate and an OLED device (light emitting) region.

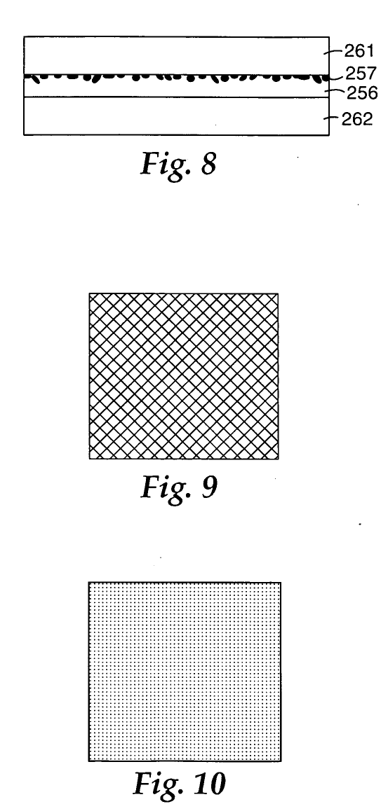

FIG. 8 illustrates low index extraction elements 257 within a high index backfill region 256 with the high index region 256 providing the planarizing layer. The extraction elements 257 and backfill 256 are located between a low index substrate 261 and an OLED device region 262. In the embodiment shown in FIG. 8, the extraction elements are concentrated in the evanescent zone. The layers shown in FIGS. 6-8 illustrate patterns and interfaces of the low index and high index structures described above.

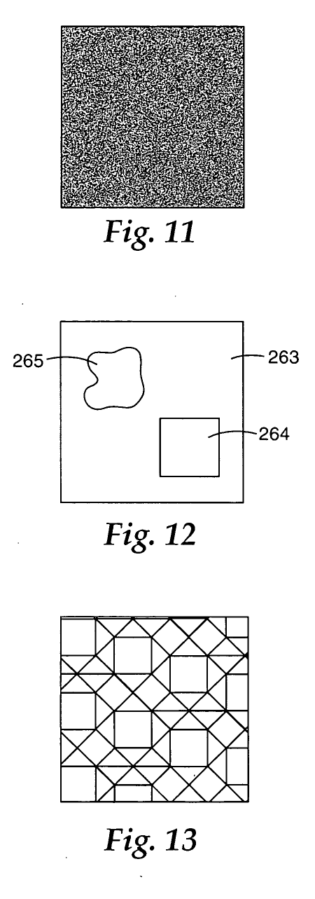

FIGS. 9-13 are top view diagrams depicting possible surface configurations of extraction elements. FIGS. 9 and 10 illustrate regular periodic arrays of extraction elements. FIG. 11 illustrates a random distribution of extraction elements. FIG. 12 illustrates patterned regions of extraction elements. In particular, FIG. 12 illustrates portions of features, possibly in a regular pattern 264 or an irregular pattern 265, interspersed within a different distribution of features 263. The regular or irregular patterns 264 and 265, respectively, along with the different distribution 263 may each have periodic, quasi-periodic, or random distributions of extraction elements. Such regions of patterns may be useful to optimize extraction of particular wavelengths of light at those regions, for example wavelengths corresponding with red, green, and blue light. In that case, the extraction regions can correspond and be aligned the red, green, and blue regions comprising pixels of a display device, and each extraction region can each be optimized to extract light from the corresponding red, green, and blue regions. FIG. 13 illustrates quasicrystal (tiled patterns) of extraction elements.

Examples of techniques for making extraction elements are described in U.S. patent application Ser. No. 11/556719, filed Nov. 6, 2006, which is incorporated herein by reference. FIGS. 9-13 illustrate possible surface configurations of the nanostructures or other extraction elements described above with a backfill medium providing the planarizing layer over the nanostructures.

Additional techniques could include using lithography or interference lithography to expose nanoscale regions in a photosensitive polymer deposited on a flexible polymer web. After the exposure and development steps, the remaining photosensitive polymer would then define a nanostructured surface. Alternatively, this nanostructured photosensitive polymer surface can serve as an etch mask for exposure of the surface in an etching process. This etching technique would transfer the nanoscale pattern into the surface of the underlying polymer web or into a layer of a harder material, such as a silicon oxide, which had been deposited on the polymer web prior to the lithographic steps. The nanoscale surface defined in any of these manners could then be backfilled with an index contrasting medium to form the light scattering or diffracting layer.

### Distributions of Nanoparticles for Light Extraction

This embodiment provides enhanced light extraction from an OLED using an index-contrasting film with randomly distributed high index nanostructures created by coating nanoparticles such as, for example, ITO, silicon nitride (Si₃N₄, referred to here as SiN), CaO, Sb₂O₃, ATO, TiO₂, ZrO₂, Ta₂O₅, HfO₂, Nb₂O₃, MgO, ZnO, In₂O₃, Sn₂O₃, AlN, GaN, TiN, or any other high index materials on a substrate used in OLED fabrication or encapsulation, and then applying a low index coating, such as SiO₂, Al₂O₃, DLG, DLC, or polymeric materials over the nanoparticles to provide the index contrast needed for scattering or diffraction efficiency and to planarize the surface. The randomly distributed nanostructures can be in contact with the substrate, proximate the substrate, grouped together in places, or in any random configuration proximate the substrate. A converse construction, potentially providing similar effectiveness, can comprise a random distribution of low index nanoparticles or nanostructures such as SiO₂, porous SiO₂, Borosilicate (BK), Al₂O₃, MgF₂, CaF, LiF, DLG, DLC, poly(methyl methacrylate) (PMMA), polycarbonate, PET, low index polymers, or any other low index materials with a contrasting high index filler material such as vapor deposited Si₃N₄ or a solvent-coated particle-filled polymer or a high index polymer.

Coating processes such as spin coating, dip coating, and knife coating may be used for distributing the nanoparticles on the surface, and a similar process may be used to coat the backfill/planarization layer. The use of such techniques should render the process simple, easily scaled for manufacturing, and suitable for incorporation in film products manufactured via web line or roll-to-roll processes.

One particular method involves applying nanoparticles having a first index of refraction onto a flexible substrate and overcoating a backfill layer on the nanoparticles to form a planarizing layer over them. The backfill layer comprises a material having a second index of refraction different from the first index of refraction. Preferably, a substantial portion of the nanoparticles are within an evanescent zone adjacent to a light emitting region of a self-emissive light source when the optical film is located against the self-emissive light source. For example, a substantial portion of the nanoparticles can be in contact with the substrate to be within the evanescent zone, although in some embodiments the substantial portion of the nanoparticles in the evanescent zone need not be in contact with the substrate.

Applying the nanoparticles can involve coating the nanoparticles dispersed in a solvent onto the flexible substrate and allowing the solvent to evaporate before overcoating the backfill layer. Applying the nanoparticles can also involve applying them in dry form to the flexible substrate and then overcoating them with the backfill layer. An alternative to the method involves using substrate with a release agent, in which the particles are applied to a substrate with a release agent, the substrate with the particles is applied to a device substrate with the particles in contact with it, and then the substrate is released to transfer the particles to the device substrate.

### Replication Method

One solution for forming a master tool having nanostructures involves the use of interference lithography. Regular periodic features as small as 100 nm-150 nm can be quickly written using this method. An advantage involves being able to write these patterns over larger areas, which can make the process more amenable to manufacturing.

Production of a master tool for replication of the pattern can involve the following. A substrate is coated with an overlayer of photoresist and then illuminated with one or more UV interference patterns to expose the resist in a regular pattern with the desired feature sizes. Development of the resist then leaves an array of holes or posts. This pattern can subsequently be transferred into the underlying substrate through an etching process. If the substrate material is not suitable to be used as a replication tool, a metal tool can be made using standard electroforming processes. This metal replica would then become the master tool.

Another method involves forming a master tool having randomly-distributed nanostructures. A solution is prepared comprising nanoparticles of the appropriate size and with the appropriate surface modifications to prevent agglomeration. Methods for preparing such solutions are generally specific to the particular nanoparticles to be dispersed; general methods have been described elsewhere, including U.S. Pat. No. 6,936,100 and Molecular Crystals and Liquid Crystals, 444 (2006) 247-255, both of which are incorporated herein by reference. The solution is then coated onto a flexible substrate using one of a variety of solvent coating techniques, including knife coating, dip coating, or spray coating. Pretreatment of the substrate using methods such as plasma etching may be required in order to assure uniformity of the solution coating. After solvent evaporation, the nanoparticles should be distributed in a way that is microscopically random but macroscopically uniform. As was the case with the uniform tool fabrication process described above, this pattern could then be transferred to an underlying substrate material through an etching or embossing process, or a metal tool can be made using standard electroforming processes.

In any of these cases, if a flat master tool has been produced, it or its replicas may then be tiled together to form a larger tool, as described in U.S. Pat. No. 6,322,652, incorporated herein by reference, or may be formed into a cylindrical tool for compatibility with a roll-to-roll replication process.

Once a master tool has been produced, replication of the structure into a polymer can be done using one of a variety of replication processes, including the 3C process. The substrate for this replication could be any polymer sheeting compatible with the chosen replication process; it may be already coated with the ultrabarrier film as described above. Backfilling would then be performed downstream in, for example, a chemical vapor deposition (CVD) or sputtering process which can deposit a high index material, such as SiN or ITO, which is capable of filling the structures and then leveling out into a smooth layer. If SiN is used, this might then be followed by an ITO deposition process if a conductive upper layer is required. Alternatively, the downstream backfilling may be performed in a solvent coating process using suitable materials.

### EXAMPLES

### Chemicals for Examples 1-5

Solplus® D510 and D520 are polymeric dispersants from Lubrizol, Cleveland, Ohio. VP Aeroperl P25/20 is titanium dioxide micro granulate from Evonik Degussa Co., Theodore, Ala.
γ-(polyalkylene oxide)propyltrimethoxysilane was available as Silquest A1230 from Momentive Performance Materials, Inc., Friendly, W. Va.).
Irgacure 184 photoinitiator, 1 -hydroxy-cyclohexyl-phenyl-ketone was obtained from Ciba Specialty Chemicals, Tarrytown, N.Y.
NTB-1 is 15% wt aqueous brookite titanium dioxide sol with pH at 4 and 7˜9, respectively, which are commercially available from Showa Denko Corporation, Japan.
Dipentaerythritol pentaacrylate (SR399) and Ethoxylated (4) bisphenol A diacrylate (SR601) were obtained from Sartomer Company, Exton, Pa. OLED material Alq is obtained from Sensient Imaging Technologies GmbH (Germany)

### Testing Methods for Examples 1-5

Refractive Index Measurements: The refractive indices of the optical coatings were measured at 632.8 nm using a Metricon MODEL 2010 prism coupler (Metricon Corporation Inc. Pennington, N.J.). The optical coating to be measured is brought into contact with the base of a Rutile prism, leaving an air gap of the order of 0.1 μm. A light beam from a laser enters the prism and strikes the base of the prism. The light is thus totally reflected at the prism base onto the photodetector. The total reflection leaves only evanescent fields in the air gap. Through these evanescent fields, the light wave from the prism is coupled into the waveguide. The prism, the sample, and the photodetector are mounted on a rotating table such that the incident angle of the laser beam can be changed correspondingly. Coupling is strongest when the follow phase matching condition is satisfied:

βₘ=κₒnₚ sin(θₘ)

where βₘ is the propagation constant, κₒ=Ω/c, nₚ is the prism refractive index and m is the coupling angle.

At certain angles of incidence, sharp reflectivity dips occur in the spectrum corresponding to the excitation of guided modes. This feature is known as the dark mode line spectrum and the dips are known as the “dark” m-lines. At, βₘ, the light is coupled into the waveguide, thus resulting in a lack of reflected light at the base of the prism, consequently forming the dark mode line spectrum. From the positions of βₘ, it is possible to determine the mode effective indices, the waveguide thickness, and the refractive index, n, of the waveguide.

### Preparation of ZrO₂ Based High Index Hardcoat Coatings (ZrO₂-HIHC) for Examples 1-5

ZrO₂-HIHC was prepared in accordance with the procedures described in U.S. Patent Application Publication No. 2006/0147674 and PCT Application Publication No. 2007/146686. Briefly, 274 g of 2-butanone, 47.05 g of SR399, 47.05 g of SR601, and 16.1 g of Irgacure 184 were added to a 2-L amber jar. The mixture was shaken until homogenous. 735.1 g of ZrO₂-SM (59.2% solids in 2-methoxy-1-propanol) was added slowly to the mixture and gently mixed until homogenous. This results in a composition containing 45 wt-% solids. The final mixture was filtered through a 0.5 micron filter.

The HIC solutions were then applied on top of PET films using a #10 wire-wound rod (obtained from RD Specialties, Webster, N.Y.). The resulting films were then dried in an oven at 85° C for 1˜2 min, then cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (1 pass). The reflective index of the resulting transparent coating is measured as 1.689 using Metricon Prism Coupler.

### Preparation of 50 nm TiO₂ Nanoparticle Dispersions for Examples 1-5

The TiO₂ nanoparticle dispersion consisted of P25/20 titanium dioxide powder, Solplus® D510, D520, and 1-methoxy-2-propanol, with 53% weight of solid. The dispersant was added in an amount of 25% wt based on titanium dioxide weight. The dispersion was first mixed by BYK-Gardner Dispermat laboratory dissolver for 10 minutes; then dispersed using a Netzsch MiniCer media mill and 0.2 mm Torayceram yttrium-stabilized milling media at 250 ml/min dispersion circulation rate. After 4 hour milling, a white paste like TiO₂ dispersion in 1-methoxy-2-propanol was obtained. The particle size was measured as 50 nm using Malvern Instruments Zetasizer Nano ZS (particle size shown in harmonic intensity-averaged particle diameter as defined in ISO13321).

### Preparation of 10 nm TiO₂ Nanoparticle Dispersion for Examples 1-5

42.8 g of aqueous dispersion of titanium dioxide sols (NTB-01, 15% wt solid, pH=4) was added to a 250 ml three-necked flask; 15 g of additional water and 45 g of 1-mehtoxy-2-propanol were added under rapidly stirring. A mixture of 1.432 g of Silquest A-174 and 0.318 g of Silquest A1230 in 5 g of 1-methoxy-2-propanol were slowly added. The mixture was heated to 80° C. and held for 16 hours under rapidly stirring. Most of the solvent was removed using rotary-evaporator. The resulting white/pale like materials was diluted in 1:1 mixture of 1-methoxy-2-propanol/MEK. The solution becomes more translucent clear, and then the solvents were further removed using rotary-evaporator to yield of translucent stable nanoparticle dispersion with 47% wt solid.

### Example 1

### Preparation of Extremely High RI Coating Using 50 nm TiO₂ and ZrO₂ Nanoparticles

In a glass jar, 4.5 g of ZrO₂ HIHC prepared as above, 6.78 g of 50 nm TiO₂ dispersion, 14.4 g of 2-butanone, 9.6 g of 1-methoxy-2-propanol were mixed together. The mixture was stirred to form a homogenous white solution. The coating solution was applied on glass and photonic crystals patterned polymer substrates using spin-coating at 4000 rpm for 30 seconds (Karl Suss spin coater, spin coater model CT62 from Suss MicroTec, Inc.), resulting a transparent high index coatings. The coatings were cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (2 pass).

The thickness of the high index coating is measured to be approximately 250 nm. For refractive index measurements, the high index coating was applied on the PET film surface using using a #12 wire-wound rod (obtained from RD Specialties, Webster, N.Y.). The resulting film was then dried in an oven at 85° C. for 1˜2 min, then cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (1 pass). The refractive index of the high index coating is measured as 1.85 using Metricon Prism Coupler.

### Example 2

### Preparation of Thinner Extremely High RI Coating Using 50 nm TiO₂ and ZrO₂ Nanoparticles

In a glass jar, 4.5 g of ZrO₂ HIHC prepared as above, 6.78 g of 50 nm TiO₂ dispersion, 24.4 g of 2-butanone, 16.62 g of 1-methoxy-2-propanol were mixed together. The mixture was stirred to form a homogenous white solution. The coating solution was applied on glass using spin-coating at 4000 rpm for 30 seconds (Karl Suss spin coater, spin coater model CT62 from Suss MicroTec, Inc.), resulting a transparent high index coatings. The coatings were cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (2 pass). The thickness of the high index coating is measured to be approximately 150-200 nm.

### Example 3

### Preparation of Extremely High RI Coating Using 10-20 nm TiO₂ Nanoparticles

TiO₂-HIC with 85% wt of surface treated TiO₂ nanoparticles was prepared as follows. 1.0 g of 2-butanone, 0.2643 g of SR399, 0.2643 g of SR601, and 0.056 g of Irgacure 184 were added to a brown container. The resins and photoinitiator were dissolved under ultrasonic bath. Then 5.313 g of surface treated TiO₂ solution at 47% wt solid was added. The mixture was further mixed under 15 min ultrasonic treatment. The final solution was filtered through 0.5 micron filter.

The HIC solutions were then applied on top of PET films using a #10 wire-wound rod (obtained from RD Specialties, Webster, N.Y.). The resulting films were then dried in an oven at 85° C. for 1˜2 min, then cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (1 pass). The refractive index of the resulting transparent coating is measured as 1.882 using Metricon Prism Coupler.

### Example 4

### Fabrication of Photonic Crystal Replicas

A layer of SiO₂ with thickness>300 nm was deposited onto the glass substrate using plasma enhanced chemical vapor deposition process. An anti-reflection (AR) coating DUV-112 produced by Brewer Science was spin coated on the SiO₂ layer with the thickness of 65 nm. Then a negative photoresist UVN30 produced by Rohm & Haas was used for patterning. The UVN30 was diluted with Thinner P that is produced by Rohm & Haas at the ratio of 1:0.35 before being spin-coated onto the top of AR coating layer on glass. Then interference lithography was used to pattern the diluted UVN30. A hole pattern was generated after two exposures with a 90 degree rotation of sample between exposures. Then reactive ion etching (RIE) process was used to transfer the hole pattern from UVN30 down to SiO₂ layer. After the RIE was completed, then the remaining UVN30 and DUV-112 was removed by oxygen plasma. A SiO₂/glass mold was generated with hole patterns on top. Several drops of acrylate (mixture of 75% photomer 6210 and 24% SR238 from Sartomer Inc. and 1% photo initiator TPO-L from BASF) were applied onto the pattern area and made to cover the top of all the structured area. Then the SiO₂/glass mold was put into vacuum oven heated up to 100° C. and vacuum was conducted to drive out the remaining air trapped inside the holes of the mold for 5 minutes. PEN film Q65F was used as carrier film of replication. The PEN film was treated in plasma cleaner for >10 minutes to increase the adhesion of film. Then PEN film was laminated onto the acrylate covered SiO₂/glass mold and caution was taken to make sure no air bubble was trapped under the PEN film. Then the PEN film laminated SiO₂/glass was put into a nitrogen purged UV chamber and cured for 9 minutes. After the UV cure was completed, the PEN film with acrylate replica wa separated from SiO₂/glass mold resulting in a photonic crystal replica of post structures.

### Example 5

### OLEDs with Extremely High Index TiO₂-Backfill Coatings onto Regular Nanostructures

Positive photonic crystal nanostructure pattern with an array of 220 nm deep cylindrical posts spaced with 500 nm pitch was fabricated on PEN film as described in Example 4. Backfill dispersion prepared according to Example 1 was spin-coated onto the nanostructure containing samples pre-cut to 50×50 mm dimensions employing procedure described in Example 2.

110 nm of indium-tin oxide (ITO) was deposited onto the backfill-coated nanostructure through a 5 mm×5 mm pixilated shadow mask defining anode geometry. Subsequently, a simple green organic emitting layer and cathode were deposited to complete the OLED. The OLEDs were fabricated by standard thermal deposition in a vacuum system at base pressure of ca. 10⁻⁶ torr. The following OLED construction was deposited: HIL(300 nm)/HTL(40 nm)/EML(30 nm,6%)/Alq(20 nm)/LiF(1 nm)/Al(200 nm).

On-axis luminance-current-voltage (LIVs) characteristics of the devices in the 0-20 mA/cm² current density range were recorded using PR650 photopic camera and Keithley 2400 Sourcemeter. On-axis LIV measurements showed approximately 2.0-2.2×OLED light extraction from the patterned pixels. Current density-voltage characteristics of the devices prepared with patterned and control pixels were very similar indicating minimal or negligible electrical differences between patterned and control devices. This suggested that electrical contribution into observed 2× enhancement was minimal.

Angular LIV measurement in the ±65° angular space conducted using the same acquisition system at the current density of 20 mA/cm2 showed enhanced luminance as well as improved emission color uniformity over over a broad range of tested angles. Luminance enhancement clearly showed specific pattern with higher light extraction efficiency at 0° and ±(40-45)° angles.

### Preparation of ZrO₂ Based High Index Hardcoat Coatings (ZrO₂-HIHC) for Examples 6-11

ZrO₂-HIHC was prepared in accordance with the procedures described in U.S. Patent Application Publication No. 2006/0147674 and PCT Application Publication No. 2007/146686. Briefly, 274 g of 2-butanone, 47.05 g of SR399, 47.05 g of SR601, and 16.1 g of Irgacure 184 were added to a 2-L amber jar. The mixture was shaken until homogenous. 735.1 g of ZrO₂-SM (59.2% solids in 2-methoxy-1-propanol) was added slowly to the mixture and gently mixed until homogenous. This resulted in a composition containing 45 wt-% solids. The final mixture was filtered through a 0.5 micron filter.

The HIC solutions were then applied on top of PET films using a #10 wire-wound rod (obtained from RD Specialties, Webster, N.Y.). The resulting films were then dried in an oven at 85° C. for 1˜2 min, then cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (1 pass). The refractive index of the resulting transparent coating was measured as 1.689 using Metricon Prism Coupler (Metricon MODEL 2010 prism coupler from Metricon Corporation Inc. Pennington, N.J.).

### Preparation of 50 nm TiO₂ Nanoparticle Dispersion for Examples 6-11

The TiO₂ nanoparticle dispersion consisted of P25/20 titanium dioxide powder, Solplus® D510, D520, and 1-methoxy-2-propanol, with 53% weight of solid. The dispersant was added in an amount of 25% wt based on titanium dioxide weight. The dispersion was first mixed by BYK-Gardner Dispermat laboratory dissolver for 10 minutes; then dispersed using a Netzsch MiniCer media mill and 0.2 mm Torayceram yttrium-stabilized milling media at 250 ml/min dispersion circulation rate. After 4 hour milling, a white paste like TiO₂ dispersion in 1-methoxy-2-propanol was obtained. The particle size was measured as 50 nm using Malvern Instruments Zetasizer Nano ZS (particle size shown in harmonic intensity-averaged particle diameter as defined in ISO13321).

### Example 6

### Preparation of Extremely-High-RI Coating Using 50 nm TiO₂ and ZrO₂ Nanoparticles

In a glass jar, 4.5 g of ZrO₂ HIHC prepared as above, 6.78 g of 50 nm TiO₂ dispersion, 14.4 g of 2-butanone, 9.6 g of 1-methoxy-2-propanol were mixed together. The mixture was stirred to form a homogenous white coating solution. The coating solution was applied on glass and patterned substrates using spin-coating at 4000 rpm for 40 seconds, resulting in transparent high index coatings. The coatings were cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (2 pass). The thickness of the high index coating was measured to be approximately 250 nm.

For refractive index measurements, the high index coating was applied on the PET film surface using a #12 wire-wound rod (obtained from RD Specialties, Webster, N.Y.). The resulting film was dried in an oven at 85° C. for 1˜2 min, then cured using the Fusion UV-Systems Inc. Light-Hammer 6 UV (Gaithersburg, Md.) processor equipped with an H-bulb, operating under nitrogen atmosphere at 100% lamp power at a line speed of 30 feet/min (1 pass). The refractive index of the high index coating was measured as 1.85 using Metricon Prism Coupler.

### Example 7

### Preparation of Thinner, Extremely-High-RI Coating Using 50 nm TiO₂ and ZrO₂ Nanoparticles

In a glass jar, 4.5 g of ZrO₂ HIHC prepared as above, 6.78 g of 50 nm TiO₂ dispersion, 24.4 g of 2-butanone, 16.62 g of 1-methoxy-2-propanol were mixed together. The mixture was stirred to form a homogenous white coating solution. The coating solution was applied on glass using spin-coating at 4000 rpm for 40 seconds (Karl Suss spin coater, spin coater model CT62 fro Suss MicroTec, Inc.), resulting in transparent high index coatings. The coatings were cured using a Fusion UV-Systems Inc. Light-Hammer 6 UV (Gaithersburg, Md.) processor equipped with an H-bulb, operating under nitrogen atmosphere at 100% lamp power at a line speed of 30 feet/min (2 pass). The thickness of the high index coating was measured to be approximately 150-200 nm.

### Example 8

### OLEDs with Extremely High Index TiO₂-Backfill Coatings onto Nanoparticles without SiN Passivation Layer (Comparative Example)

Dispersions of 93 nm silica nanoparticles were obtained from the Nalco company. Polyvinyl alcohol (PVA, 98 mole % hydrolyzed, MW 78000) was obtained from Polysciences, Inc. and was dissolved in water with 0.5% solid content for the related experiments. Dodecylbenzenesulfonic sodium salt (DS-10) surfactant was obtained from Alderich.

A silica nanoparticle dispersion solution (93 nm, 0.5 wt %, 0.1-1 wt % DS-10) was coated on PET film (6-8 mil thickness) by a dip-coating method at a speed of 65 mm/min. The resulting coating was dried in air at room temperature, then subsequently further dried at 100° C. for 5 minutes. The silica-nanoparticle-coated film was then over-coated with a 60 nm thick layer of silicon nitride by plasma-enhanced chemical vapor deposition for stabilization of the nanoparticles (PECVD, Model PlasmaLab™ System100 available form Oxford Instruments, Yatton, UK). The parameters used in the PECVD process are described in Table 4.

TABLE 4
Conditions Used for Depositing SiN Layer

| Reactant/Condition | Value |
|---|---|
| SiH₄ | 400 sccm |
| NH₃ | 20 sccm |
| N₂ | 600 sccm |
| Pressure | 650 mTorr |
| Temperature | 100° C. |
| High frequency (HF) power | 20 W |
| Low frequency (LF) power | 20 W |

The refractive index of the SiN core layer was measured using a Metricon Model 2010 Prism Coupler and was found to be 1.7. Backfill dispersion prepared according to Example 6 was spin-coated onto the nanoparticle-coated samples pre-cut to 50×50 mm dimensions, employing the procedure described in Example 7. At the completion of the TiO₂-polymer backfill coating, a light extraction layer containing the low-index scattering nanostructure planarized with the high index backfill was produced.

Approximately 110 nm-thick ITO was deposited onto the backfill-coated nanoparticles structures through a 5 mm×5 mm pixilated shadow mask to define the anode geometry.

Subsequently, a simple green organic emitting layer and cathode were deposited to complete the OLED. The OLEDs were fabricated by standard thermal deposition in a vacuum system at base pressure of ca. 10⁻⁶ Torr. The following OLED construction was deposited: HIL(300 nm)/HTL(40 nm)/EML(30 nm,6%)/Alq(20 nm)/ LiF(1 nm)/Al(200 nm). After completion, the OLED was encapsulated with encapsulation barrier film (3M Company) employing SAES getter as a desiccant and oxygen scavenger in between the encapsulation film and the OLED cathode.

That OLED pixel exhibited substantial decay even after a few days of storage under ambient conditions with almost complete deterioration of the pixel emission pattern by 3 weeks of storage.

### Example 9

### OLEDs with Extremely High Index TiO₂-Backfill Coatings onto Nanoparticles with SiN Passivation Layer

A dispersion of silica nanoparticles (93 nm, 0.5 wt %, 0.1-1 wt % DS-10) was coated on PET film (6-8 mil thickness) by a dip-coating method as in Example 8. The nanoparticle-coated film was then coated with a 60 nm layer of silicon nitride by PECVD for stabilization of the nanoparticles, as in Example 8. Then backfill dispersion prepared according to Example 6 was spin-coated onto the nanoparticles containing samples pre-cut to 50×50 mm dimensions employing the procedure described in Example 7.

Before deposition of the ITO anode, an additional 60 nm-thick SiN passivation layer was deposited on top of the TiO₂-polymer backfill to avoid any reactions between the TiO₂-polymer and ITO anode. The SiN deposition parameters were the same as Example 8 (listed in Table 4).

Next 110 nm of ITO for the anode was deposited onto the backfill-coated nanoparticless structures through a 5 mm×5 mm pixilated shadow mask defining the anode geometry. Subsequently, a simple green organic emitting layer and cathode were deposited to complete the OLED. The OLEDs were fabricated by standard thermal deposition in a vacuum system at base pressure of ca. 10⁻⁶ Torr. The following OLED construction was deposited: HIL(300 nm)/HTL(40 nm)/EML(30 nm,6%)/Alq(20 nm)/ LiF(1 nm)/Al(200 nm). After completion, the OLED was encapsulated with encapsulation barrier film (3M Company) employing SAES getter as a desiccant and oxygen scavenger in between the encapsulation film and the OLED cathode.

This very thin SiN (60 nm) passivation layer at the high index TiO₂-polymer/ITO interface was shown to significantly reduce pixel shrinkage and degradation. This feature may be due to the components in the TiO₂-polymer formulation reacting with the ITO anode. From LIV measurements it was also demonstrated that introducing the SiN passivation layer did not lead to any significant change in extraction efficiency.

### Example 10

### OLEDs with Extremely High Index TiO₂-Backfill Coatings on Replicated Photonic Crystals without the SiN Passivation Layer (Comparative Example)

A replicated polymer photonic crystal was prepared as described in Example 4. A high index TiO₂-based backfill layer, ITO anode layer and OLED structures were also fabricated according to procedures described Example 5. Thereby, an OLED device of the following structure was fabricated: HIL(300 nm)/HTL(40 nm)/EML(30 nm,6%)/Alq(20 nm)/LiF(1 nm)/Al(200 nm). This device did not employ the SiN passivation layer at the high index backfill/ITO interface. Time-based EL microscopy studies were conducted analogous to those described in Examples 3 and 4. The EL micrographs revealed that similarly to nanoparticle-based extraction films filled with the TiO₂ backfills, photonic crystal based films also undergo quick pixel shrinkage degradation of OLED pixels.

### Example 11

### OLEDs with Extremely High Index TiO₂-Backfill Coatings onto Replicated Photonic Crystal using the SiN Passivation Layer

A replicated photonic crystal was prepared according to procedures described in Example 4. The high index TiO₂-based backfill layer, ITO anode layer and OLED structure were also fabricated according to procedures described in Example 5. Prior to ITO deposition and after the deposition and curing of the TiO₂-based high index backfill layer, an additional 60 nm-thick SiN passivation layer was deposited onto the top of the TiO₂-polymer backfill to avoid any reactions between the TiO₂-polymer and ITO anode. The SiN deposition parameters were the same as in Example 8 (listed in Table 4). Thereby, an OLED device of the following structure was fabricated: HIL(300 nm)/HTL(40 nm)/EML(30 nm,6%)/Alq(20 nm)/LiF(1 nm)/Al(200 nm); this time the OLED device incorporated the SiN passivation layer at the high index backfill/ITO interface. Time-based EL microscopy studies were conducted analogous to those described in Examples 3 and 4. As observed for the nanoparticle-based extraction layer (Example 9), the passivation layer was shown to effectively reduce pixel shrinkage degradation of the OLED devices on the timescale of the experiment.

Moreover, in spite of slightly lower refractive index of the SiN passivation layer than the TiO₂-based backfill layer, neither on-axis nor angular luminance-current-voltage characteristics of the devices employing the passivation layer were affected. It is believed that the passivation layer can be implemented with any other high index material with low permeability, such as ZrO₂, TiO₂, HfO₂, Ta₂O₅, and the like.

1. A multifunctional optical film for enhancing light extraction from a self-emissive light source, comprising:
a flexible substrate;
a structured layer of extraction elements having a first index of refraction, wherein a substantial portion of the extraction elements are in optical communication with a light emitting region of the self-emissive light source when the optical film is located against the self-emissive light source; and
a backfill layer comprising a material having a second index of refraction different from the first index of refraction, wherein the backfill layer forms a planarizing layer over the extraction elements and wherein a difference between an index of refraction of the structured layer and an index of refraction of the backfill layer is greater than or equal to 0.3.

2. The multifunctional optical film of claim 1, wherein the index of refraction of the backfill layer is greater than 1.8.

3. The multifunctional optical film of claim 1, wherein the index of refraction of the structured layer is less than or equal to 1.5.

4. The multifunctional optical film of claim 1, wherein the extraction elements comprise nanostructured features.

5. The multifunctional optical film of claim 1, wherein the backfill layer material comprises a nanoparticle filled polymer material.

6. The multifunctional optical film of claim 1, wherein the substrate comprises one of the following: a polymer film; a substantially optically transmissive material; or a barrier material.

7. The multifunctional optical film of claim 1, further comprising a passivation layer located adjacent the backfill layer on a surface opposite the structured layer.

8. The multifunctional optical film of claim 7, wherein the passivation layer comprises an optically transparent high index material with low permeability.

9. A method for making an optical film for enhancing light extraction, comprising:
coating a layer of an organic material having a first index of refraction onto a flexible substrate;
imparting nanostructured features into the organic material to create a nanostructured surface; and
applying a backfill layer to the nanostructured surface to form a planarizing layer on the nanostructured surface,
wherein the backfill layer comprises a material having a second index of refraction different from the first index of refraction and wherein a difference between an index of refraction of the nanostructured features and an index of refraction of the backfill layer is greater than or equal to 0.3, and
wherein a substantial portion of the nanostructured features are in optical communication with a light emitting region of a self-emissive light source when the optical film is located against the self-emissive light source.

10. The method of claim 9, wherein the index of refraction of the backfill layer is greater than 1.8.

11. The method of claim 9, wherein the index of refraction of the nanostructured features is less than or equal to 1.5.

12. The method of claim 9, wherein the imparting step comprises:
providing a master tool having nanostructured features; and
applying the flexible substrate with the layer of the organic material to the tool with the organic material applied against the tool to impart the nanostructures into the organic material.

13. The method of claim 9, wherein the imparting step comprises printing the nanostructured features onto the organic material.

14. The method of claim 9, wherein the imparting step comprises embossing the nanostructured features into the organic material.

15. The method of claim 9, further comprising using one of the following methods to apply the backfill layer to form the planarizing layer: liquid coating; vapor coating; powder coating; lamination; dip-coating; or roll-to-roll coating.

16. The method of claim 9, further comprising applying a passivation layer to the backfill layer on a surface opposite the structured layer.

17. The method of claim 16, wherein the passivation layer comprises an optically transparent high index material with low permeability.

18. A method for making an optical film for enhancing light extraction, comprising:
applying nanoparticles having a first index of refraction onto a flexible substrate, wherein a substantial portion of the nanoparticles are in optical communication with a light emitting region of a self-emissive light source when the optical film is located against the self-emissive light source; and
overcoating a backfill layer on the nanoparticles to form a planarizing layer over the nanoparticles, wherein the backfill layer comprises a material having a second index of refraction different from the first index of refraction and a difference between an index of refraction of the nanoparticles and an index of refraction of the backfill layer is greater than or equal to 0.3.

19. The method of claim 18, wherein the index of refraction of the backfill layer is greater than 1.8.

20. The method of claim 18, wherein the index of refraction of the nanoparticles is less than or equal to 1.5.

21. The method of claim 18, wherein the applying step comprises:
coating the nanoparticles dispersed in a solvent onto the flexible substrate; and
allowing the solvent to evaporate before overcoating the backfill layer.

22. The method of claim 18, wherein the applying step comprises applying the nanoparticles in dry form to the flexible substrate.

23. The method of claim 18, further comprising applying a passivation layer to the backfill layer on a surface opposite the structured layer.

24. The method of claim 23, wherein the passivation layer comprises an optically transparent high index material with low permeability.
